(19) United States
(12) Patent Application Publication
(10) Pub. No.: US 2021/0405740 A1
(43) Pub. Date: Dec. 30, 2021

(54) CONVERGING OF CONTENT FROM MULTIPLE DISPLAY SOURCES

(71) Applicant: LENOVO ENTERPRISE SOLUTIONS (SINGAPORE) PTE. LTD., SINGAPORE (SG)

(72) Inventors: MATTHEW R. ALCORN, DURHAM, NC (US); JAMES G. MCLEAN, RALEIGH, NC (US); YOUSSEF JOUAD, DURHAM, NC (US)

(21) Appl. No.: 16/915,388

(22) Filed: Jun. 29, 2020

(51) Int. Cl. G06F 3/01; G06F 3/14; G09G 3/20

(52) U.S. Cl. CPC G06F 3/013; G06F 3/1446; G09G 2354/00; G09G 2340/04; G09G 2300/026; G09G 3/20

(57) ABSTRACT

Converging of content from multiple display sources includes receiving eye tracking information related to a user including a first area of interest comprising content displayed on a first screen and a second area of interest comprising content displayed on a second screen; converging, in dependence upon the received eye tracking information, the content of the first and second areas of interest; and displaying the converged content on a single screen.

### BACKGROUND

### Field of the Invention

The field of the present disclosure is content convergence, or, more specifically, methods, apparatus, and products for converging of content from multiple display sources.

### Description of Related Art

People view content from different display sources, while working, in an office or in a larger area with many screens, or for recreation, at home or in a public area. People check multiple displays for different types of information.

Existing solutions include users manually checking multiple monitors or relying on large groups of displays that contain content of interest and content not of interest. Therefore, a way to learn which areas of content on multiple displays the user is interested in, using eye tracking technology, and merging that content into a single display is desired.

### SUMMARY

Methods, systems, and apparatus for converging of content from multiple display sources are disclosed in this specification. Methods, systems, and apparatus for converging of content from multiple display sources includes receiving eye tracking information related to a user including a first area of interest comprising content displayed on a first screen and a second area of interest comprising content displayed on a second screen; converging, in dependence upon the received eye tracking information, the content of the first and second areas of interest; and displaying the converged content on a single screen.

The foregoing and other objects, features and advantages of the disclosure will be apparent from the following more particular descriptions of exemplary embodiments of the present disclosure as illustrated in the accompanying drawings wherein like reference numbers generally represent like parts of exemplary embodiments of the present disclosure.

### BRIEF DESCRIPTION OF THE DRAWINGS

FIG. 1 sets a block diagram of automated computing machinery including an example computer useful in converging of content from multiple display sources according to embodiments of the present disclosure.

FIGS. 2A and 2B set forth a diagram of an example system used in converging of content from multiple display sources according to embodiments of the present disclosure.

FIGS. 3A and 3B set forth a diagram of an example system used in converging of content from multiple display sources according to embodiments of the present disclosure.

FIG. 4 sets forth a flow chart illustrating an exemplary method for converging of content from multiple display sources according to embodiments of the present disclosure.

FIG. 5 sets forth a flow chart illustrating an exemplary method for converging of content from multiple display sources according to embodiments of the present disclosure.

FIG. 6 sets forth a flow chart illustrating an exemplary method for converging of content from multiple display sources according to embodiments of the present disclosure.

### DETAILED DESCRIPTION

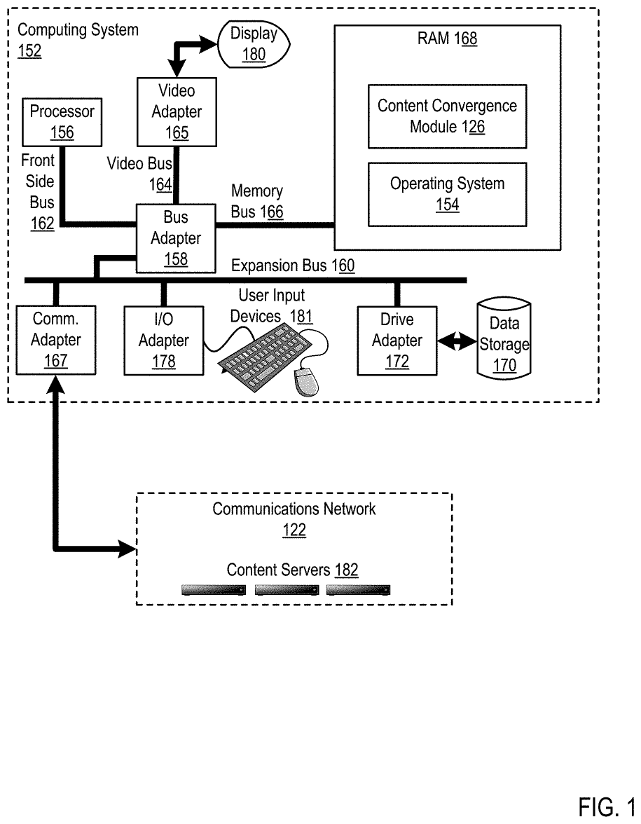

Exemplary methods, apparatus, and products for converging of content from multiple display sources in accordance with the present invention are described with reference to the accompanying drawings, beginning with FIG. 1. FIG. 1 sets forth a block diagram of automated computing machinery comprising an exemplary computing system (152) configured for converging of content from multiple display sources according to embodiments of the present invention.

Eye tracking, as used here, refers to local or remote eye tracking using infrared, near-infrared or environmental light. Eye tracking may use a fixed light source next to a fixed camera or may use a moveable camera or multiple fixed or moveable cameras. Eye tracking may use a camera mounted on the head of the user, above or below or beside the eyes. The camera or cameras may be capable of taking up to 2000 or more images of both eyes every second. Within milliseconds, the images are processed and the area on a screen where the user is looking is determined. Eye tracking software uses image processing algorithms to identify the center of the pupil and the center of the corneal reflection on each of the images sent by the eye tracking. The corneal reflection is the reflection of a light source which may be located next to the camera.

When the head of the user is stationary, the location of the corneal reflection (CR) remains relatively fixed on the camera sensor because the source of the reflection does not move relative to the camera. When the eye rotates, the location of the center of pupil on the camera sensor changes. The direction of the gaze can be calculated from this information. As the head of the user moves in small side-to-side movements or in larger movements across a room, the location of the pupil on the eye tracking camera sensor shifts. Both the pupil and the corneal reflection move on the camera sensor. Eye tracking software distinguishes between changes in pupil position on the camera sensor that result from rotations of the eye from those that result from movements of the head by tracking the relationship between the center of the pupil and the center of the corneal reflection. With head movements the relationship between the center of the pupil and the center of the corneal reflection remains the same whereas when the eye rotates, the relationship changes.

FIG. 1 sets forth a block diagram of automated computing machinery comprising an exemplary computing system (152) configured for converging of content from multiple display sources according to embodiments of the present disclosure. The computing system (152) of FIG. 1 includes at least one computer processor (156) or “CPU” as well as random access memory (168) (“RAM”) which is connected through a high speed memory bus (166) and bus adapter (158) to processor (156) and to other components of the computing system (152).

Stored in RAM (168) is an operating system (154). Operating systems useful in computers configured for man converging of content from multiple display sources according to embodiments of the present disclosure include UNIX™, Linux™, Microsoft Windows, AIX′, IBM's iOS™, and others as will occur to those of skill in the art. The operating system (154) in the example of FIG. 1 is shown in RAM (168), but many components of such software typically are stored in non-volatile memory also, such as, for example, on a disk drive (170). Also stored in RAM (168) and part of the operating system is a content convergence module (126), a module of computer program instructions for converging of content from multiple display sources.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of disk drive (170). Disk drive adapters useful in computers configured for man converging of content from multiple display sources according to embodiments of the present disclosure include Integrated Drive Electronics (“IDE”) adapters, Small Computer System Interface (“SCSI”) adapters, and others as will occur to those of skill in the art. Non-volatile computer memory also may be implemented for as an optical disk drive, electrically erasable programmable read-only memory (so-called “EEPROM” or “Flash” memory), RAM drives, and so on, as will occur to those of skill in the art.

The example computing system (152) of FIG. 1 includes one or more input/output (“I/O”) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (165), which is an example of an I/O adapter specially designed for graphic output to a display device (180) such as a display screen or computer monitor. Video adapter (165) is connected to processor (156) through a high speed video bus (164), bus adapter (158), and the front side bus (162), which is also a high speed bus.

The exemplary computing system (152) of FIG. 1 includes a communications adapter (167) for data communications with other computers (182) and for data communications with a data communications network. Such data communications may be carried out serially through RS-232 connections, through external buses such as a Universal Serial Bus (“USB”), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for converging of content from multiple display sources according to embodiments of the present disclosure include modems for wired dial-up communications, Ethernet (IEEE 802.3) adapters for wired data communications, and 802.11 adapters for wireless data communications.

The communications adapter (167) of the exemplary computing system (152) of FIG. 1 is connected to a communications network (122) via a communications bus. The communications network (122) is in communication with other content servers (182) including set-top boxes, satellite feeds, and the Internet.

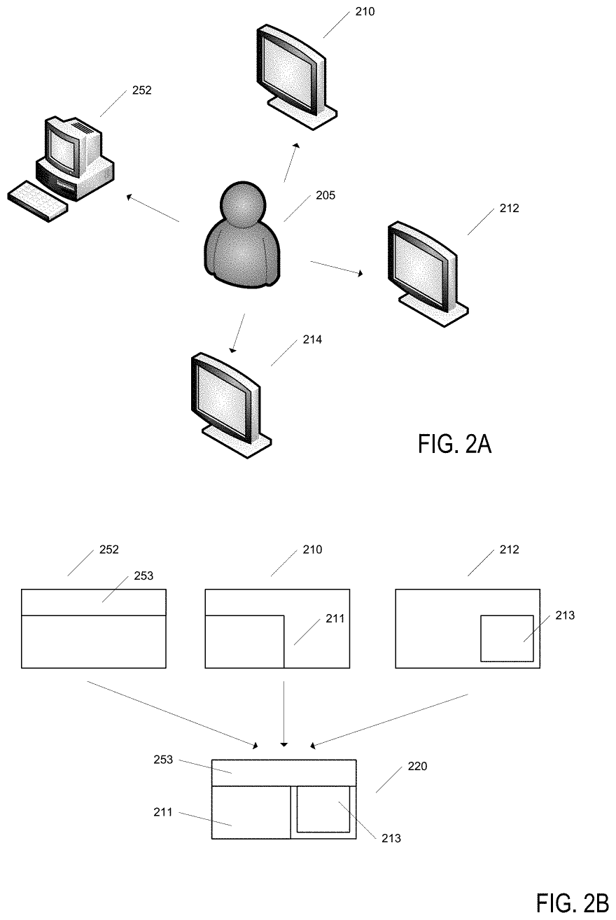

For further explanation, therefore, FIG. 2A sets forth a line drawing of exemplary screens as well as automated computing machinery including an example computer (252) useful in converging of content from multiple display sources according to embodiments of the present invention.

FIG. 2A shows a user (205) who views content from different display sources or screens (210, 212, 214, 252). The display sources or screens (210, 212, 214, 252) may be television screens or computer monitors or may be other screens such as a phone, tablet, or laptop. Each of the display sources or screens (210, 212, 214, 252) displays one or more content feeds. Content feeds can include, for example, information from websites with URLs, broadcast or cable TV, or other streaming content. Each of the display sources or screens (210, 212, 214, 252) may show one content feed or may have more than one pane of different content. Computer (252) may perform a screen analysis to determine likely content break points by examining shifts in color of lighting or searching for outlines of content based on common geometric shapes. Computer (252) may determine different areas of interest for display sources or screens that have multiple content feeds in different areas. Alternatively, user (205) or an administrator may designate areas of interest on some or all of the screens. Computer (252) may have direct access to the content feeds on each display source, such as URLs, or may receive the content feeds passively or upon request from other content servers such as set-top boxes, satellite feeds, and others. It should be understood that computer (252) may be a smart television or computer monitor or may be another form of computer such as a phone, tablet, or laptop or may be a distributed computer among screens (210, 212, 214, 252) and other local or remote computers (not shown).

Eye trackers (not shown) may be located at or near each display source or screen (210, 212, 214, 252) or may be stationed in other areas of the room. The eye trackers may be fixed or may be moveable, for example, on a rail or other moveable mounting system. Each of the eye trackers may focus on the eyes of user (205) to determine the direction of the gaze. An eye tracker may alternately or additionally be mounted on the head of user (205), above or below or beside the eyes. Eye tracking information from the eye trackers may be used to determine the areas of interest that the user gazes at.

FIG. 2B shows different panes of content on the display sources or screens (210, 212, 252). For example, screen (252) shows two panes of content that are divided into two areas of interest. The upper area of interest (253) is one that user (205) may focus his gaze at more than the lower area of interest. Similarly, screen (210) has an area of interest in the lower left (211) that is one that user (205) may focus his gaze at more than the other portions of screen (210). Screen (212) has an area of interest in the lower right (213) that is one that user (205) may focus his gaze at more than the other portions of screen (212). For example, a stock exchange worker may be interested in viewing a stock ticker from one source, a press conference on a different monitor, and another report on a different screen. In another example, a worker may view an email on one screen, streamed entertainment on a different screen, and a document on a third screen.

Computer (252) may converge the content that is viewed more frequently by user (205) onto one screen, for example, onto display screen (252) or display screen (214). The converged content is shown, for example, in FIG. 2B on screen (220). The converged content shown on screen (220) may be formatted to fit the screen properly, including resizing, cropping, rearranging, or other formatting.

Additionally, computer (252) may track the viewing habits of user (205) over time and create and update a user profile of long-term preferences. Further, computer (252) may generate new user profiles for each viewing session, or a combination of the two. Alternatively, computer (252) may manage a plurality of auto- or user-generated or user-selectable user profiles.

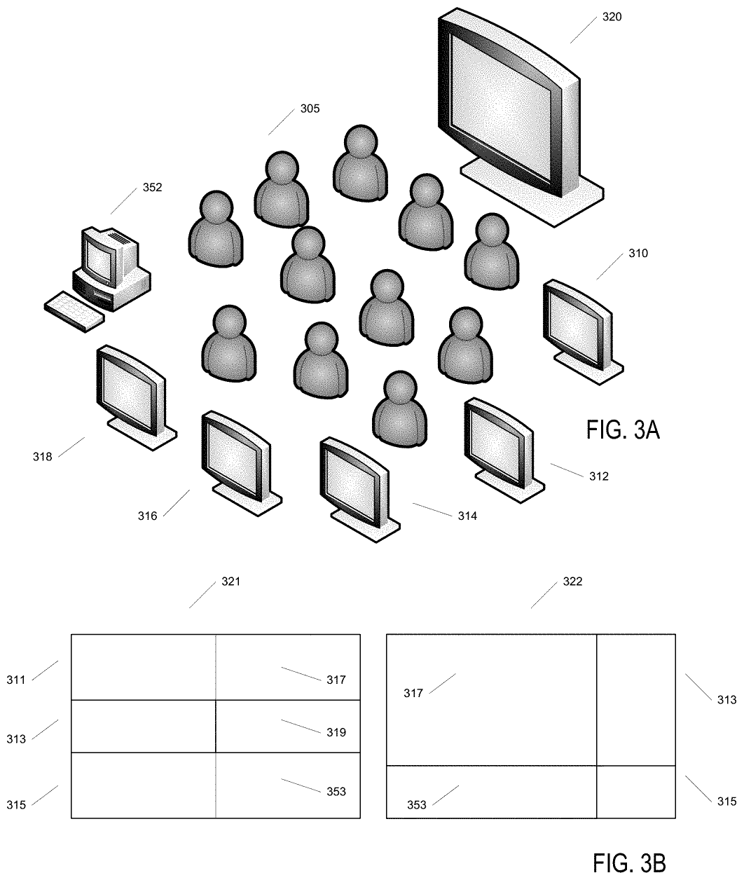

For further explanation, FIG. 3A sets forth a line drawing of exemplary screens as well as automated computing machinery including an example computer (352) useful in converging of content from multiple display sources according to embodiments of the present invention.

As described above in reference to FIG. 2A, FIG. 3A shows many users (305) who view content from different display sources or screens (310, 312, 314, 316, 318, 352, 320). The display sources or screens (310, 312, 314, 316, 318, 352, 320) may be television screens or computer monitors or may be other screens such as a phone, tablet, or laptop. Screen (320) is shown as an example large screen or wall screen that may be larger than the other screens (310, 312, 314, 316, 318, 352). Each of the display sources or screens (310, 312, 314, 316, 318, 352, 320) displays one or more content feeds, including, for example, information from URLs, broadcast or cable TV or other streaming content. Each of the display sources or screens (310, 312, 314, 316, 318, 352, 320) may show one content feed or may have more than one pane of different content. Computer (352) may perform a screen analysis to determine likely content break points by examining shifts in color of lighting or searching for outlines of content based on common geometric shapes. Computer (352) may determine different areas of interest for display sources or screens that have multiple content feeds in different areas. Alternatively, one or more of the users (305) or an administrator may designate areas of interest on some or all of the screens. Computer (352) may have direct access to the content feeds on each display source, such as URLs, or may receive the content feeds passively or upon request from other content servers such as set-top boxes, satellite feeds, and others. It should be understood that computer (352) may be a smart television or computer monitor or may be another form of computer such as a phone, tablet, or laptop or may be a distributed computer among screens (310, 312, 314, 316, 318, 352, 320) and other local or remote computers (not shown).

As described above in reference to FIG. 2A, eye trackers (not shown) may be located at or near each display source or screen (310, 312, 314, 316, 318, 352, 320) or may be stationed in other areas of the room. The eye trackers may be fixed or may be moveable, for example, on a rail or other moveable mounting system. The eye trackers may focus on the eyes of each of the users (305) to determine the direction of the gaze. Eye trackers may alternately or additionally be mounted on the heads of some or all users (305), above or below or beside the eyes.

As described above in reference to FIG. 2A, computer (352) may track the viewing habits of users (305) over time and create and update user profiles of long-term preferences. Further, computer (352) may generate new user profiles for each user for each viewing session, or a combination of the two. Alternatively, computer (352) may manage a plurality of auto- or user-generated user profiles. Computer (352) may determine different profiles for different users (305) using log-ins or user selection, facial recognition, or other methods.

Computer (352) may converge the content that is viewed more frequently by the users (305) onto one screen, for example, onto large display screen (320). The converged content is shown, for example, in FIG. 3B on screen (321, 322). The converged content shown on screen (321, 322) may be formatted to fit the screen properly, including resizing, cropping, rearranging, or other formatting.

Because there are many users (305) viewing many screens (310, 312, 314, 316, 318, 352), large display screen (320) may show converged content with equal visual priority and scaled to be equivalent size (321). As described above in reference to FIG. 2B, FIG. 3B shows converged content with areas of interest (311, 313, 315, 317, 319, 353) from screens (310, 312, 314, 316, 318, 352) that users (305) may focus their gaze at more than other areas of interest. Alternatively, computer (352) may converge content intelligently and focus content by giving valuable screen real estate to more popular content on large display screen (322) while removing the least popular content. For example, content viewed by more users (305) or viewed for a longer period of time may be considered to be more popular (317, 353, 313, 315) and thus may occupy more screen space and be displayed in a larger or more prominent way. As engagement levels shift over time, an area of converged content may become less important or less popular and may be refreshed or updated to accurately display important content. Computer (352) may determine that users (305) are viewing other content on display source or screen (310, 312, 314, 316, 318, 352) and add, delete, or resize the converged content on display screen (320). Additionally, computer (352) may add other content to display screen (320) according to user profiles or that is generally popular. It should be understood that computer (252) may similarly converge content viewed by single user (205) intelligently and focus content on screen (220) by increasing the screen size of more popular content and reducing the screen size of less popular content.

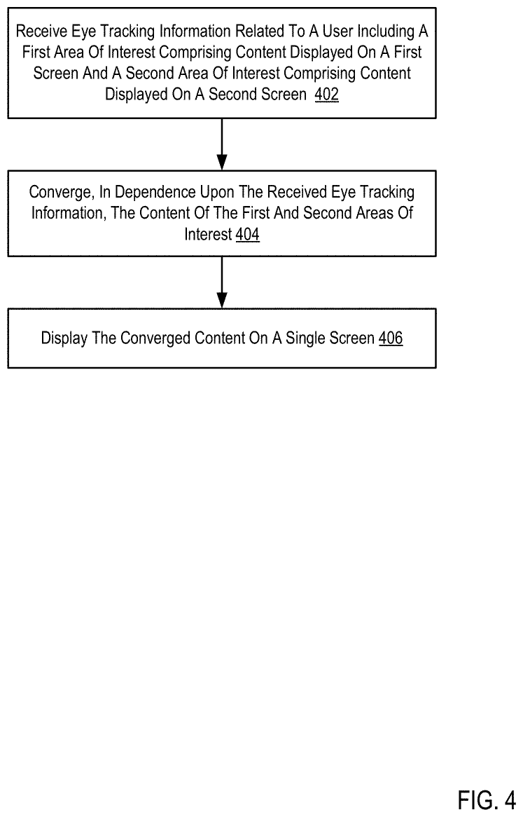

For further explanation, FIG. 4 sets forth a flow chart illustrating an exemplary method for converging of content from multiple display sources according to embodiments of the present disclosure. The method of FIG. 4 includes receiving (402) eye tracking information related to a user including a first area of interest comprising content displayed on a first screen and a second area of interest comprising content displayed on a second screen. Receiving (402) eye tracking information related to a user including a first area of interest comprising content displayed on a first screen and a second area of interest comprising content displayed on a second screen includes receiving eye tracking information from one or more eye tracking cameras located on or near a screen or mounted on a user or elsewhere in a room. As described above, areas of interest can be automatically determined or can be designated by a user or an administrator. Additionally, a plurality of eye tracking information for a plurality of users and a plurality of areas of interest on a plurality of screens may be received. An area of interest can be the entire content of a screen or a pane or portion of the screen.

FIG. 4 also includes converging (404), in dependence upon the received eye tracking information, the content of the first and second areas of interest. As described above, content in an area of interest from the first screen and content in an area of interest from the second screen are converged.

FIG. 4 also includes displaying (406) the converged content on a single screen. The single screen may be the first or second screen or a third screen. As described above, content in an area of interest from one screen and content in an area of interest from at least one other screen are converged into a single screen. The converged content can be formatted to display properly onto the single screen, by cropping, resizing, or rearranging, for example. The content may be focused by increasing the size of more popular content and reducing the size of less popular content.

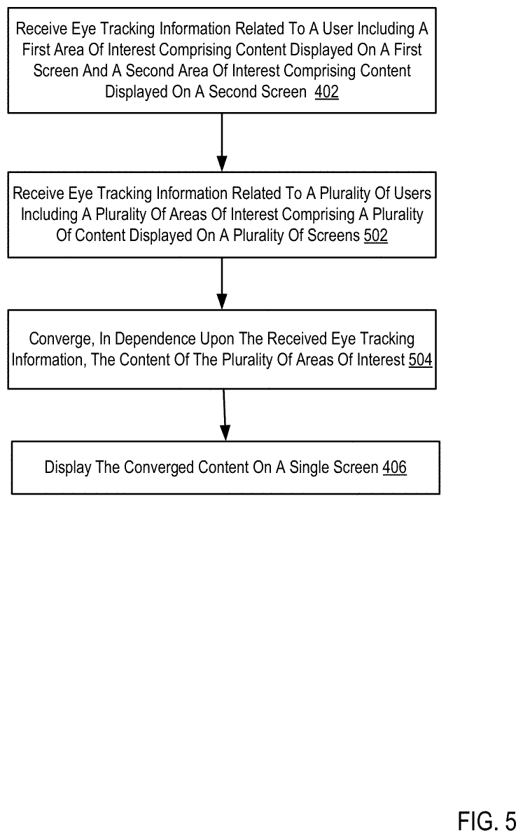

For further explanation, FIG. 5 sets forth a flow chart illustrating an exemplary method for converging of content from multiple display sources according to embodiments of the present disclosure that includes receiving (402) eye tracking information related to a user including a first area of interest comprising content displayed on a first screen and a second area of interest comprising content displayed on a second screen and displaying (406) the converged content on a single screen. The single screen may be the first or second screen or a third screen.

The method of FIG. 5 differs from the method of FIG. 4, however, and includes receiving (502) eye tracking information related to a plurality of users including a plurality of areas of interest comprising a plurality of content displayed on a plurality of screens. Receiving (502) eye tracking information related to a plurality of users including a plurality of areas of interest comprising a plurality of content displayed on a plurality of screens includes receiving eye tracking information from one or more eye tracking cameras located on or near one or more screens or mounted on one or more users or elsewhere in a room. As described above, areas of interest can be automatically determined or can be designated by a user or an administrator.

FIG. 5 also includes converging (504), in dependence upon the received eye tracking information, the content of the plurality of areas of interest. As described above, content in an area of interest from some or all of the plurality of screens is converged.

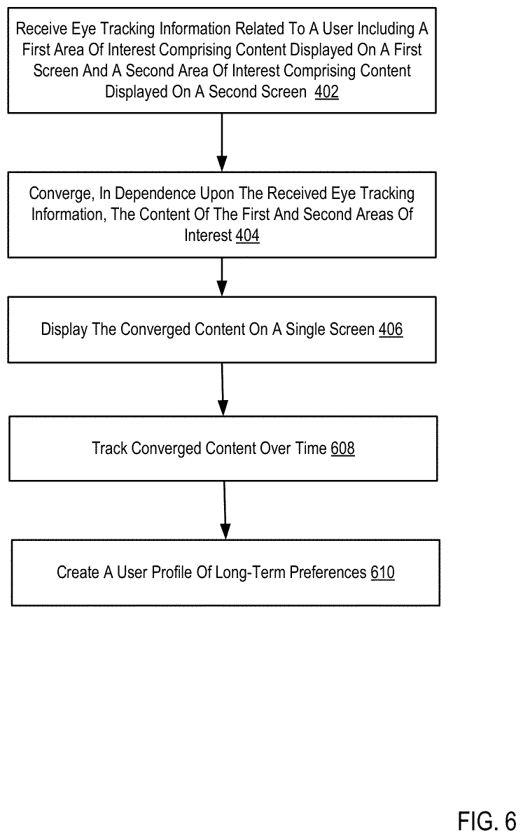

For further explanation, FIG. 6 sets forth a flow chart illustrating an exemplary method for converging of content from multiple display sources according to embodiments of the present disclosure that includes receiving (402) eye tracking information related to a user including a first area of interest comprising content displayed on a first screen and a second area of interest comprising content displayed on a second screen; converging (404), in dependence upon the received eye tracking information, the content of the first and second areas of interest; and displaying (406) the converged content on a single screen. The single screen may be the first or second screen or a third screen.

The method of FIG. 6 differs from the method of FIG. 4, however, and includes tracking (608) the converged content over time. Tracking (608) the converged content over time includes tracking content that is preferred by a user including content preferred at different times or overall preferred content.

FIG. 6 also includes creating (610) a user profile of long-term preferences. The user profile can include content that is preferred by a user including content preferred at different times or overall preferred content.

In view of the explanations set forth above, readers will recognize that the benefits of converging of content from multiple display sources according to embodiments of the present disclosure include:
Providing preferred content from multiple monitors in one local screen.
Consolidating preferred content.

Exemplary embodiments of the present disclosure are described largely in the context of a fully functional computer system for automatic resource configuration through workload analysis. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method comprising:
by program instructions on a computing device,
receiving eye tracking information related to a user including a first area of interest comprising content displayed on a first screen and a second area of interest comprising content displayed on a second screen;
converging, in dependence upon the received eye tracking information, the content of the first and second areas of interest; and
displaying the converged content on a single screen.

2. The method of claim 1, further comprising:
receiving eye tracking information related to a plurality of users including a plurality of areas of interest comprising a plurality of content displayed on a plurality of screens,
wherein converging content includes converging, in dependence upon the received eye tracking information, the content of the plurality of areas of interest.

3. The method of claim 1, wherein the single screen is the first screen.

4. The method of claim 1, wherein the single screen is a third screen.

5. The method of claim 1, wherein displaying the converged content includes focusing the content by scaling content that is more popular to be larger than content that is less popular.

6. The method of claim 1, further comprising:
tracking converged content over time; and
creating a user profile of long-term preferences.

7. The method of claim 1, wherein the converged content is formatted to fit the single screen, wherein the content of the first area of interest is a portion of content displayed on the first screen, and wherein the content of the second area of interest is a portion of content displayed on the second screen.

8. An apparatus comprising a computing device, a computer processor, and a computer memory operatively coupled to the computer processor, the computer memory storing computer program instructions that are configured to, when executed by the computer processor, cause the apparatus to perform operations comprising:
receiving eye tracking information related to a user including a first area of interest comprising content displayed on a first screen and a second area of interest comprising content displayed on a second screen;
converging, in dependence upon the received eye tracking information, the content of the first and second areas of interest; and
displaying the converged content on a single screen.

9. The apparatus of claim 8, further comprising:
receiving eye tracking information related to a plurality of users including a plurality of areas of interest comprising a plurality of content displayed on a plurality of screens,
wherein converging content includes converging, in dependence upon the received eye tracking information, the content of the plurality of areas of interest.

10. The apparatus of claim 8, wherein the single screen is the first screen.

11. The apparatus of claim 8, wherein the single screen is a third screen.

12. The apparatus of claim 8, wherein displaying the converged content includes focusing the content by scaling content that is more popular to be larger than content that is less popular.

13. The apparatus of claim 8, further comprising:
tracking converged content over time; and
creating a user profile of long-term preferences.

14. The apparatus of claim 13, wherein the converged content is formatted to fit the single screen, wherein the content of the first area of interest is a portion of content displayed on the first screen, and wherein the content of the second area of interest is a portion of content displayed on the second screen.

15. A computer program product comprising a computer readable storage medium and computer program instructions stored therein that are configured to, when executed by a processor, cause a computer to perform operations comprising:
receiving eye tracking information related to a user including a first area of interest comprising content displayed on a first screen and a second area of interest comprising content displayed on a second screen;
converging, in dependence upon the received eye tracking information, the content of the first and second areas of interest; and
displaying the converged content on a single screen.

16. The computer program product of claim 15, further comprising:
receiving eye tracking information related to a plurality of users including a plurality of areas of interest comprising a plurality of content displayed on a plurality of screens,
wherein converging content includes converging, in dependence upon the received eye tracking information, the content of the plurality of areas of interest.

17. The computer program product of claim 15, wherein the single screen is the first screen.

18. The computer program product of claim 15, wherein the single screen is a third screen.

19. The computer program product of claim 15, wherein displaying the converged content includes focusing the content by scaling content that is more popular to be larger than content that is less popular.

20. The computer program product of claim 15, further comprising:
tracking converged content over time; and
creating a user profile of long-term preferences.
